(19) United States
(12) Patent Application Publication
(10) Pub. No.: US 2002/0056205 A1
(43) Pub. Date: May 16, 2002

(54) Alignment marks

(75) Inventor: Toshiaki Koshitaka, Tokyo (JP)

Correspondence Address: Norman P. Soloway, HAYES, SOLOWAY, HENNESSEY,, GROSSMAN & HAGE, P.C., 175 Canal Stree, Manchester, NH, 03101, US

(73) Assignee: NEC Corporation

(21) Appl. No.: 10/035,520

(22) Filed: Nov. 9, 2001

(30) Foreign Application Priority Data
Nov. 10, 2000 (JP) 343985/2000

(51) Int. Cl. G01D 21/00

(52) U.S. Cl. 33/645

(57) ABSTRACT

The alignment marks of the present invention, which are to be used for alignment of a wafer, have a slit pattern with a plurality of slits arranged upon the wafer; and a dot pattern with a plurality of dots arranged along the length of the slits at the outer regions of two of the plurality of slits, which are at the ends thereof.

### BACKGROUND OF THE INVENTION

1. Field of the Invention

The present invention is related to alignment marks used for the alignment of a wafer.

2. Description of the Prior Art

When manufacturing a semiconductor apparatus, design patterns of elements, interconnects and the like are formed using optic lithography. In the lithography step during the manufacture of a semiconductor apparatus, several alignment marks formed upon a wafer are detected and the alignment of the wafer and a mask is performed; thereafter, through the exposing and developing of the design pattern, which is upon the mask, a resist pattern is formed onto the resist layer of the wafer.

Conventionally, a reducing projection exposure apparatus (stepper) is generally used in the lithography step of the semiconductor apparatus manufacturing process. At the time of exposure in an alignment method using a reducing projection exposure apparatus, photographing of an image of a wafer surface having predetermined alignment marks with a CCD camera, subjecting the photographed image to image processing, and carrying out arithmetic processing of the obtained image data in order to align a wafer is known.

An example of a conventional alignment mark pattern will now be described using the drawings. FIG. 5 is a top view schematically illustrating a mask having an alignment mark pattern according to a conventional example. FIG. 6 is a top view and a cross-sectional view (between B-B′) schematically illustrating a wafer after alignment marks are formed according to the conventional example. FIG. 7 is a signal waveform during measurement of the alignment marks according to the conventional example.

In a contact step, wafer 120 is etched using mask 110 as shown in FIG. 5, and by forming alignment marks of a plurality of slits 121 in a row on wafer 120, both outer edges of the slits on either end take on tapered form 123. As a result, the portions of tapered form 123 become dark when measured, and the peaks of the signals in those regions become large at both end portions of the marks as shown in FIG. 7. Namely, with a reducing projection exposure apparatus, since gain is amplified using a large peak as a reference, the repetitive portion of the peaks in the middle region of the alignment pattern becomes extremely small compared to both ends. Consequently, there are problems such as these repetitive portions being regarded as noise in image processing, not being able to precisely recognize the alignment marks, and the accuracy of wafer alignment dropping.

### BRIEF SUMMARY OF THE INVENTION

Object of the Invention

The object of the present invention is to provide alignment marks that allow for improvement in the accuracy of wafer alignment.

Summary of the Invention

The alignment marks of the present invention, which are to be used for alignment of a wafer, have a slit pattern with a plurality of slits arranged upon the wafer, and a dot pattern with a plurality of dots arranged along the length of the slits at the outer regions of two of the plurality of slits, which are at the ends thereof.

### BRIEF DESCRIPTION OF THE DRAWINGS

The above-mentioned and other objects, features and advantages of this invention will become more apparent by reference to the following detailed description of the invention taken in conjunction with the accompanying drawings, wherein:

FIG. 1 is a top view schematically illustrating a mask having an alignment mark pattern according to an embodiment of the present invention;

FIGS. 2A and 2B are a top view and cross-sectional view (between A-A′) schematically illustrating a wafer after alignment marks are formed according to an embodiment of the present invention;

FIG. 3 is a signal waveform of image data during measurement of alignment marks according to an embodiment of the present invention;

FIGS. 4A and 4B are schematics illustrating an alignment pattern according to another embodiment of the present invention;

FIG. 5 is a top view schematically illustrating a mask having an alignment mark pattern according to a conventional example;

FIGS. 6A and 6B are a top view and cross-sectional view (between B-B′) schematically illustrating a wafer after alignment marks are formed according to a conventional example; and

FIG. 7 is a signal waveform of image data when alignment marks are measured according to a conventional example.

### DETAILED DESCRIPTION OF THE INVENTION

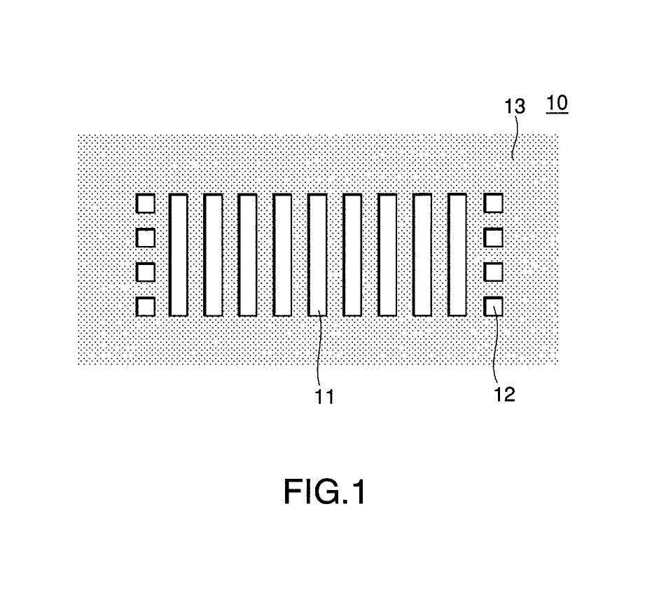

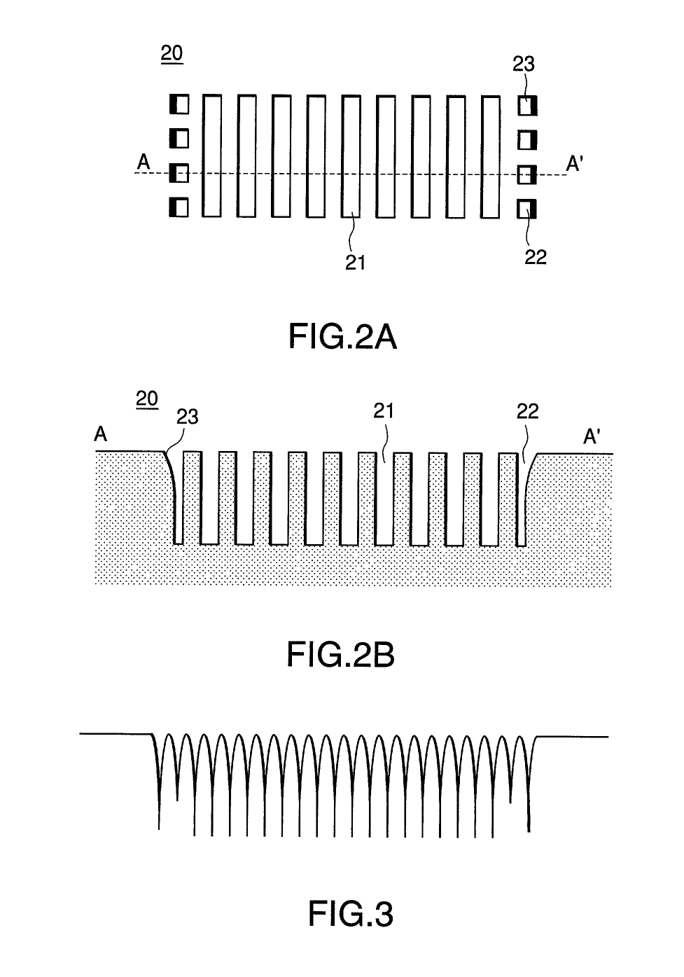

The embodiments of the present invention will be described using the drawings. FIG. 1 is a top view schematically illustrating a mask having an alignment mark pattern according to an embodiment of the present invention. FIG. 2 is a top view and cross-sectional view (between A-A′) schematically illustrating a wafer after alignment marks are formed according to an embodiment of the present invention.

Referring to FIG. 1, the alignment mark pattern of this mask 10 has a slit pattern with a plurality of slits 11 arranged, and a dot pattern with a plurality of dots 12 arranged along the length of the slits at the outer regions of both ends of the aforementioned slits 11. In this case, chrome 13 is used for the mask.

In a contact step, the alignment mark pattern formed on mask 10 of FIG. 1 is exposed, and after etching the wafer, alignment marks are formed on the wafer as in FIG. 2, causing both outer ends of dot pattern 12 to take on tapered form 23. In an alignment step, the wafer is exposed, and with the alignment marks formed on this wafer used as a reference, alignment is carried out.

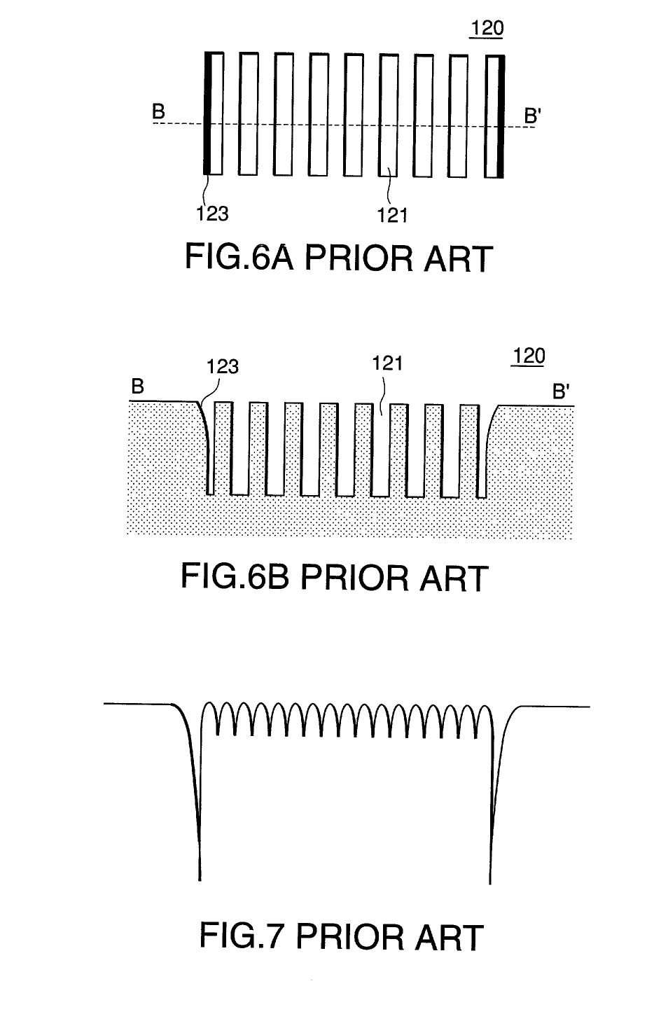

Next, a signal waveform with respect to the alignment marks at the time of exposure will be illustrated. FIG. 3 is a signal waveform of image data during measurement of alignment marks according to an embodiment of the present invention. At the time of exposure, the average of signal waveforms obtained through the image processing of a wafer image of a wafer having the alignment marks made in the contact step that is photographed with a CCD camera, is found between scanning lines. Accordingly, in this embodiment wherein both ends are dot patterns, compared to the case of the conventional example where both ends have a tapered slit form (see FIG. 6), peaks of the signals at both ends of the marks become small (compare to FIG. 7). Therefore, the alignment marks of this embodiment allow the reducing projection exposure apparatus to detect the over all signal peaks corresponding to the alignment marks; and in the wafer alignment step, it becomes possible to accurately perform alignment using the alignment marks formed on the wafer as a reference. In the arithmetic processing after alignment mark recognition, alignment accuracy may be improved by using only the slit pattern and omitting of the dot pattern.

The minimum required dot size of the dot pattern is such that the signal strength of the slit regions is at least 25% of that at both ends of the dot regions. This is because if it is smaller than 25%, there is a time when the signals of the slit regions are recognized as noise and the alignment marks cannot be accurately recognized. In order to allow more accurate recognition, a dot size that makes the signal strength of the slit regions be from 30 to 40% or more of that at both ends of the dot regions is preferable. Moreover, it is most suitable that the dot size be such that the signal strength of the slit regions and at both ends of the dot regions is approximately the same.

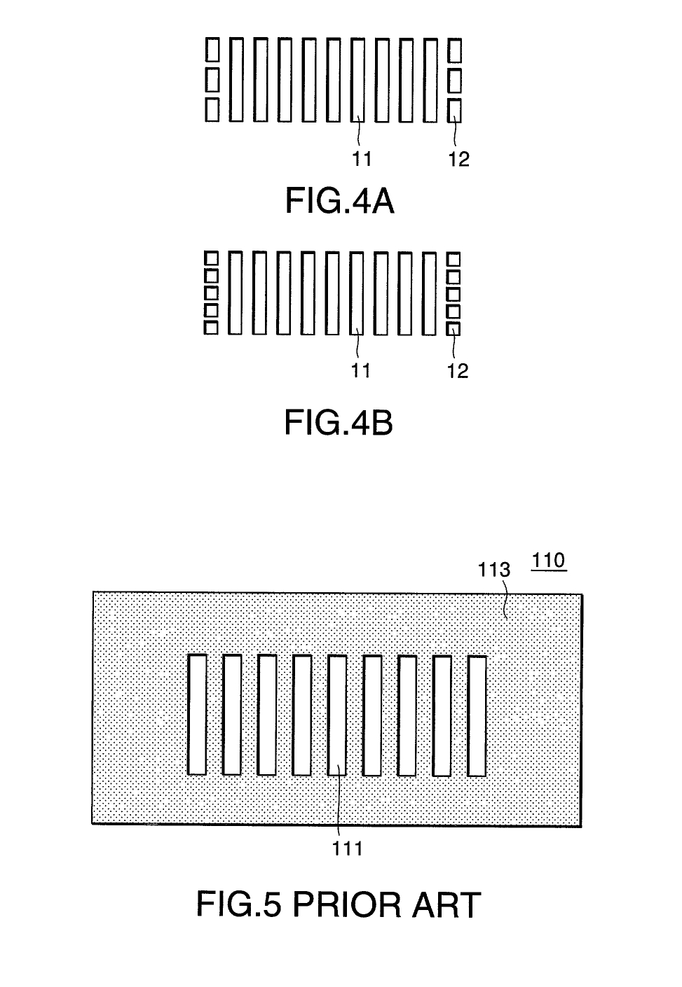

An example of dot size is illustrated in FIGS. 4A and 4B. FIGS. 4A and 4B are schematics illustrating an alignment pattern according to another embodiment of the present invention. 4A shows the case where the width of the dots along the length of the slits is elongated while the number of dots is decreased; 4B shows the case where the width of the dots along the length of the slits is shortened while the number of dots is increased. By increasing/decreasing the number of dots and adjusting the width of the dots, adjustments are made such that the signal strength of the slit regions is at least 25% of that at both ends of the dot region.

As long as the dot is not the same size as the slit, the number of dots may be one or preferably two or more. The dot shape, as seen from the top surface, is not limited to being a rectangle but may even have rounded corners.

According to the present invention, since alignment marks can be accurately recognized with a reducing projection exposure apparatus, even if both ends of the alignment marks have a tapered form, improvement in the accuracy of wafer alignment is made possible.

Although the invention has been described with reference to specific embodiments, this description is not meant to be construed in a limiting sense. Various modifications of the disclosed embodiments will become apparent to persons skilled in the art upon reference to the description of the invention. It is therefore contemplated that the appended claims will cover any modifications or embodiments as fall within the true scope of the invention.

What is claimed is:

1. Alignment marks used for alignment of a wafer comprising
a slit pattern with a plurality of slits arranged upon said wafer; and
a dot pattern with a plurality of dots arranged along the length of the slits at the outer regions of two of the plurality of slits, which are at the ends thereof.

2. The alignment marks mentioned in claim 1 wherein said dot pattern is juxtapositionally configured approximately parallel with respect to the long axis of said slits.

3. The alignment marks mentioned in claim 1 wherein dot size of said dot pattern, seen from a cross-section along the width of said slits, is adjusted so as to be large enough to make the signal strength in each slit region become at least 25% that of the dot regions at both ends.

4. The alignment marks mentioned in claim 1 wherein dot size of said dot pattern, seen from a cross-section along the width of said slits, is adjusted so as to be large enough to make the signal strength in each slit region become at least 30% that of the dot regions at both ends.

5. The alignment marks mentioned in claim 1 wherein dot size of said dot pattern, seen from a cross-section along the width of said slits, is adjusted so as to be large enough to make the signal strength in each slit region become the same as that of the dot regions at both ends.
